(19) United States
(12) Patent Application Publication
(10) Pub. No.: US 2012/0070186 A1
(43) Pub. Date: Mar. 22, 2012

(54) ELECTROPHOTOGRAPHIC IMAGE FORMING APPARATUS

(75) Inventors: Ken Kikuchi, Mishima-shi (JP); Tsutomu Nishiuwatoko, Numazu-shi (JP); Takashi Akutsu, Odawara-shi (JP)

(73) Assignee: CANON KABUSHIKI KAISHA, Tokyo (JP)

(21) Appl. No.: 13/231,655

(22) Filed: Sep. 13, 2011

(30) Foreign Application Priority Data
Sep. 22, 2010 (JP) 2010-212400
Jul. 21, 2011 (JP) 2011-160154

(51) Int. Cl. G03G 15/00; G03G 21/18

(52) U.S. Cl. 399/110; 399/123; 399/111

(57) ABSTRACT

An electrophotographic image forming apparatus for forming an image on a recording medium includes a cartridge configured to store developer, a transfer member located opposite an electrophotographic photosensitive member and configured to transfer a developed image formed on the electrophotographic photosensitive member to the recording medium, a supporting member that is movable, while supporting the cartridge, between an image forming position where image formation is conducted inside an apparatus body of the electrophotographic image forming apparatus and an attachment/detachment position which is spaced away from the image forming position and where attachment/detachment of the cartridge is feasible, and a waste developer container supported so as to be attachable/detachable with respect to the supporting member, having a cleaning member configured to remove the developer from a surface of the transfer member, and configured to store the developer removed by the cleaning member.

### BACKGROUND OF THE INVENTION

1. Field of the Invention

The present invention relates to an electrophotographic image forming apparatus in which a cartridge is detachably attached to an apparatus body and which forms an image on a recording medium. An electrophotographic image forming apparatus (hereinafter referred to as an image forming apparatus) forms an image on a recording medium by using an electrophotographic image forming process. Examples of an image forming apparatus include a copying machine, a printer (such as a laser beam printer and a light emitting diode (LED) printer), and a facsimile apparatus.

The recording medium is a medium on which an image is formed by an image forming apparatus. Examples of the recording medium include paper and an overhead transparency (OHT) sheet. The cartridge contributes to an image forming process for forming an image on a recording medium while detachably attached to the apparatus body of an image forming apparatus.

The cartridge accommodates at least developer (toner) used to develop an electrostatic latent image formed on an electrophotographic photosensitive member, and is detachably attached to a cartridge supporting member. Thus, the cartridge facilitates the maintenance of the apparatus body.

2. Description of the Related Art

Japanese Patent Application Laid-Open No. 2006-184901 discusses an image forming apparatus capable of forming a color image. In the image forming apparatus, a cartridge tray, serving as a supporting member on which a plurality of cartridges are mounted, is drawn out in a direction that is the same as the direction in which the cartridges are adjacent to each other, whereby it is possible to easily perform a cartridge replacement operation.

In the image forming apparatus discussed in Japanese Patent Application Laid-Open No. 2006-184901, a developing device storing developer is provided inside a pullout member. When the developer in the developing device has been consumed, the pullout member is pulled out to thereby perform the replacement of the developing device. Further, attached to a belt holder, separately from the pullout member, is a cleaning device configured to scrape off and store waste developer remaining on a conveyance belt. When the cleaning device has been filled with waste developer, the belt holder is pulled out, and the cleaning device is replaced with a new one. Regarding the developing device, the cleaning device, etc., which are members of relatively high frequency of replacement, it is necessary for the user to replace them with new ones by operating separate units (the pullout member and the belt holder), so that the replacement operation is a bother for the user.

### SUMMARY OF THE INVENTION

The present invention is directed to an electrophotographic image forming apparatus improved in terms of the operation of replacing a cartridge, which stores developer, and a waste developer container, which stores waste developer, with new ones.

According to an aspect of the present invention, an electrophotographic image forming apparatus for forming an image on a recording medium includes a cartridge configured to store developer, a transfer member located opposite an electrophotographic photosensitive member and configured to transfer a developed image formed on the electrophotographic photosensitive member to the recording medium, a supporting member that is movable, while supporting the cartridge, between an image forming position where image formation is conducted inside an apparatus body of the electrophotographic image forming apparatus and an attachment/detachment position which is spaced away from the image forming position and where attachment/detachment of the cartridge is feasible, and a waste developer container supported so as to be attachable/detachable with respect to the supporting member, having a cleaning member configured to remove the developer from a surface of the transfer member, and configured to store the developer removed by the cleaning member.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a vertical sectional left side view of an image forming apparatus according to a first exemplary embodiment of the present invention.

FIG. 2 illustrates a method of attaching and detaching a cartridge and a waste developer container.

FIG. 3 is a right side perspective view of a cartridge attachment portion of the image forming apparatus.

FIG. 4 is a left side perspective view of the cartridge attachment portion of the image forming apparatus.

FIG. 5 is a perspective view of a supporting member.

FIG. 6 is a sectional view of the cartridge.

FIG. 7 is a right side perspective view of the cartridge.

FIG. 8 is an explanatory view illustrating a method of attaching and detaching the cartridge and the waste developer container to and from the supporting member.

FIG. 9 is a sectional view of the water developer container.

FIG. 10 is a right side perspective view of the waste developer container.

FIG. 11A is an explanatory view illustrating the method of attaching and detaching the cartridge and the water developer container to and from the supporting member, and FIG. 11B is a perspective view of the cartridge and the waste developer container as attached to the supporting member.

FIG. 12 is a mechanism perspective view illustrating a state in which pressing by a pressing member with respect to the cartridge and the waste developer container has been released.

FIG. 13 is a mechanism perspective view illustrating a state in which the pressing member is pressing the cartridge and the waste developer container.

FIG. 14A is a mechanism perspective view illustrating a state in which pressing by a pressing member according to a second exemplary embodiment of the present invention has been released, and FIG. 14B is a mechanism perspective view illustrating a state in which pressing by the pressing member according to the second exemplary embodiment is being effected.

FIG. 15 is a perspective view illustrating a drive transmission mechanism for the pressing member according to the second exemplary embodiment.

### DESCRIPTION OF THE EMBODIMENTS

Various exemplary embodiments, features, and aspects of the invention will be described in detail below with reference to the drawings.

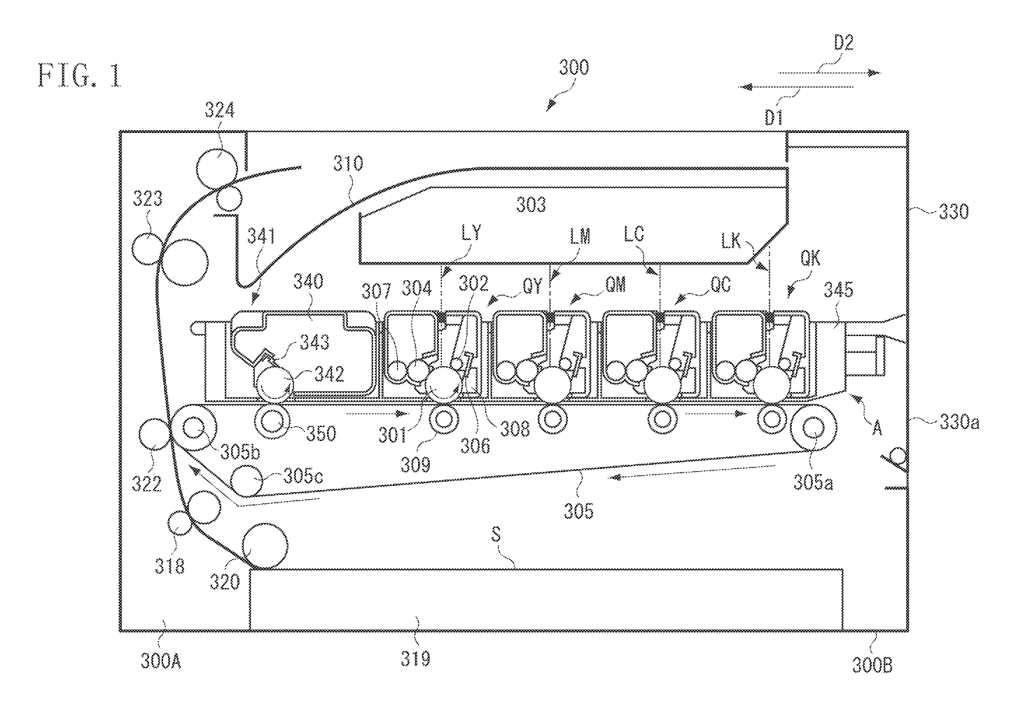

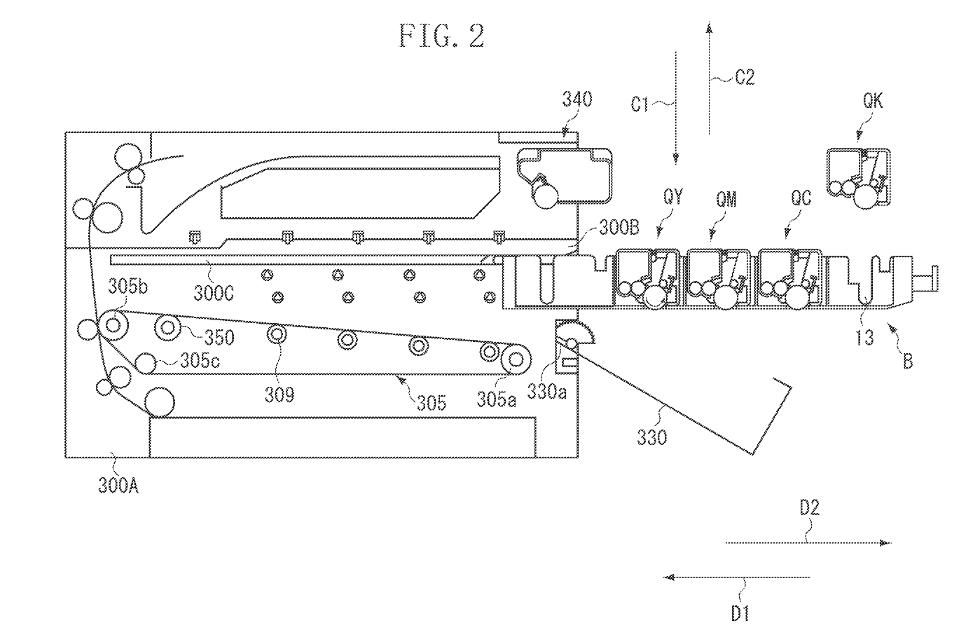

FIG. 1 is a vertical sectional left side view of an image forming apparatus 300 according to a first exemplary embodiment of the present invention, and FIG. 2 is an explanatory view illustrating a method of attaching and detaching a cartridge and a waste developer container 340.

The image forming apparatus 300 is a full-four-color laser printer adopting the electrophotographic process. Inside an apparatus body 300A, the image forming apparatus 300 is equipped with four electrophotographic photosensitive drums 301 arranged longitudinally side by side in the horizontal direction.

Around each drum 301, there are arranged successively in the rotating direction indicated by an arrow, a charging unit (charging roller) 302 configured to uniformly charge the surface of the drum 301, and a scanner unit 303 configured to apply a laser beam based on image information to form an electrostatic latent image on the drum 301.

Further, there are arranged a developing roller 304 developing the electrostatic latent image with toner serving as the developer, and an intermediate transfer member (transfer member) 305 located opposite the drum 301 in order to transfer a toner image (developed image) on the drum 301 onto a recording medium S.

Further, there is arranged a cleaning unit 306 configured to remove developer remaining on the surface of the drum 301 after the transfer.

The drum 301, the charging unit 302, the developing roller 304, and the cleaning unit 306 integrally form a cartridge QY, QM, QC, or QK (In the following, when referred to collectively, the cartridge QY, QM, QC, or QK will be referred to as the cartridge Q). In illustrating the cartridge Q, the first cartridge QY will be used as a representative example of the cartridge Q.

The cartridge QY stores yellow (Y) developer, and forms a yellow developed image on the surface of the drum 301. The second cartridge QM stores magenta (M) developer, and forms a magenta developed image on the surface of the drum 301. The third cartridge QC stores cyan (C) developer, and forms a cyan developed image on the surface of the drum 301. The fourth cartridge QK stores black (K) developer, and forms a black developed image on the surface of the drum 301.

At a position adjacent to the first cartridge QY, there are provided a cleaning member 341 for removing residual toner adhering to the transfer member 305 and a waste developer container 340 storing the waste developer removed by the cleaning member 341. When toner has been consumed by the user to terminate its service life, each cartridge Q allows replacement of the cartridge as a whole. The container 340 also allows replacement when it has been filled with waste developer in an amount not less than a prescribed amount. Further, the container 340 has a discrimination unit for discrimination between itself and the cartridge Q. Thus, although the cartridge Q and the container 340 are mounted on the same supporting member, the user is free from confusion between them when replacing each of them.

The discrimination unit may be of any type so long as it allows the user to visually discriminate between the two components; for example, it may consist of two different labels respectively affixed to the container 340 and the cartridge Q. Alternatively, such discrimination is feasible by making the size and appearance of the container 340 different from those of the cartridge Q. Further, it is also possible to form the container 340 as a transparent one so that the user may easily detect any waste developer contained therein. Further, through a combination of the above devices, such discrimination can be made reliably.

The operation of forming a full-color image is as follows. The drum 301 of each cartridge Q is driven to rotate at a predetermined control speed counterclockwise as indicated by an arrow in FIG. 1. The roller 302 follows the drum 301 in rotation. Further, the transfer member 305 is also driven to rotate clockwise as indicated by an arrow (in conformity with the rotation of the drum 301) at a speed corresponding to the speed of the drum 301. The transfer member 305 is a flexible dielectric endless belt, which is stretched between a driving roller 305a, a secondary transfer counter roller 305b, and a tension roller 305c.

Further, the developing roller 304 and a supply roller 307 are driven to rotate at respective control speeds. The unit 303 is also driven. In synchronization with this driving, there is applied, in each cartridge Q, a predetermined charging bias to the roller 302 with a predetermined control timing. As a result, the surface of the drum 301 is uniformly charged to a predetermined polarity/potential by the roller 302. The unit 303 performs scanning exposure on the surfaces of the drums 301 of the cartridges Q with laser beams L (LY, LM, LC, and LK) modulated according to image signals of the colors of Y, M, C, and K. As a result, electrostatic latent images in conformity with the image signals of the corresponding colors are formed on the surfaces of the drums 301 of the cartridges Q. In each cartridge Q, the electrostatic latent image formed on the surface of the drum 301 is developed as a developed image by the roller 304. In each cartridge Q, a predetermined developing bias is applied to the roller 304 with a predetermined control timing. Through the above electrophotographic image forming process operation, a Y-color developed image corresponding to the Y-color component of the full-color image is formed on the drum 301 of the cartridge QY.

Then, the developed image is primarily transferred onto the transfer member 305 at a primary transfer nip portion, which is an abutment portion between the drum 301 and the transfer member 305. Numeral 309 indicates a primary transfer roller, which is held in press contact with the drum 301 with the transfer member 305 therebetween. As a result, the primary transfer nip portion is formed. Similarly, in the cartridge QM, a Y-color developed image is primarily transferred to the transfer member 305 via the drum 301; in the cartridge QC, a C-color developed image, and, in the cartridge QK, a K-color developed image, undergo a similar primary transfer process.

In this way, a full-four-color unfixed developed image of Y, M, C, and K colors is formed in combination on the transfer member 305. The order in which the developers of the different colors are transferred to the transfer member 305 and superimposed one upon the other is not restricted to the above order. In each cartridge Q, transfer residual developer remaining on the drum surface after the primary transfer of the developed image to the transfer member 305 is removed by a blade (cleaning unit) 306, and is sent to a cleaning container 308. On the other hand, a feeding roller 320 is driven with a predetermined control timing. As a result, a sheet-like recording medium S stacked and accommodated in a feeding cassette 319 is fed. Then, the recording medium S is introduced into a secondary transfer nip portion, which is an abutment portion between the transfer member 305 and a secondary transfer roller 322, with a predetermined control timing by a registration roller pair 318.

A secondary transfer bias of a polarity opposite to the charging polarity of the developer and of a predetermined potential is applied to the secondary transfer roller 322 with a predetermined control timing. As a result, as the recording medium S is held in and conveyed through the secondary transfer nip portion, the developed images in four colors superimposed one upon the other on the transfer member 305 successively undergo secondary transfer onto the surface of the recording medium S. The recording medium S having passed through the secondary transfer nip portion is separated from the surface of the transfer member 305, and is introduced into a fixing device 323 to undergo heating/pressure at a fixing nip portion.

As a result, color mixing of the developed images of the different colors and fixing thereof to the recording medium S are effected. Then, the recording medium S leaves the fixing device 323, and is discharged onto a discharge tray 310 by a discharge roller pair 324 as an object on which a full-color image has been formed.

In the present exemplary embodiment, the roller 322 is movable by a shift mechanism (not illustrated) between a first position where it is held in contact with the transfer member 305 to form the secondary transfer nip portion and a second position spaced away from the intermediate transfer member 305 in a non-contact manner. Then, when the image forming apparatus 300 is to perform image formation, the roller 322 is moved to the first position, and when no image is to be formed, it is moved to the second position. It is also possible for the roller 322 to be constantly held in contact with the transfer member 305.

After the recording medium S has been separated from the surface of the transfer member 305, secondary transfer residual toner remaining on the surface of the transfer member 305 electrostatically adheres to the surface of a cleaning roller 342 serving as a cleaning member 341. Then, the adhering toner is scraped off by a cleaning blade 343 held in contact with the roller 342, and is stored in a container 340. Here, the cleaning roller 342 and the cleaning blade 343 are combined with each other to serve as the cleaning member 341. Instead of providing the cleaning roller 342, it is also possible to scrape off the residual toner by directly bringing the cleaning blade 343 into contact with the surface of the transfer member 305. In this case, solely the cleaning blade 343 constitutes the cleaning member 341.

A supporting member 13 will be illustrated, which supports the drum 301 and which is movable between an inner position situated on the inner side of the apparatus body and an outer position situated on the outer side of the apparatus body.

In the exemplary embodiment, the term “apparatus body” refers to the various members (components) constituting the image forming apparatus 300, excluding at least the supporting member 13 and members (components) formed so as to allow fixation to and attachment/detachment to/from the supporting member 13.

As illustrated in FIG. 2, the supporting member 13 is provided so as to allow linear movement (forcing-in/pulling-out) substantially in horizontal directions (indicated by arrows D1 and D2) with respect to the apparatus body. The supporting member 13 can be moved to a position where it is accommodated in the apparatus body (the position illustrated in FIG. 1) or to a position where it has been drawn out to the exterior of the apparatus body (the position illustrated in FIG. 2).

With the supporting member 13 being at the drawn-out position, the cartridges Q and the container 340 are attached to the supporting member 13 by the user substantially in the gravitational direction (the direction indicated by the arrow C1 in FIG. 2). The cartridges Q and the container 340 thus attached are arranged such that the longitudinal direction (the axial direction of the drums 301) is orthogonal to the moving direction of the supporting member 13. The four cartridges Q are arranged side by side in the moving direction of the supporting member 13. The container 340 is also arranged in the moving direction of the supporting member 13 so as to be adjacent to the cartridges Q.

While attached to the supporting member 13, the cartridges Q move within the apparatus body together with the supporting member 13. When a door 330 is closed, with the supporting member 13 moved to the interior of the apparatus body, all the cartridges Q are attached to predetermined positions in the apparatus body.

In this way, in the image forming apparatus 300 according to the present exemplary embodiment, it is possible to collectively attach the four cartridges Q and the container 340 to the interior of the apparatus body, and to collectively draw the four cartridges Q and the container 340 to the exterior of the apparatus body. Thus, as compared with the construction in which the cartridges are individually attached to the interior of the apparatus body, the construction according to the present exemplary embodiment is superior in terms of operability at the time of replacement of the cartridges Q. Further, the cartridges Q and the container 340 are attached to the same supporting member 13, whereby it is possible to collectively perform the replacement of the cartridges Q and the replacement of the container 340. Thus, there is no need to individually perform the operation of replacing the cartridges Q and the container 340, which means the construction is superior in terms of operability.

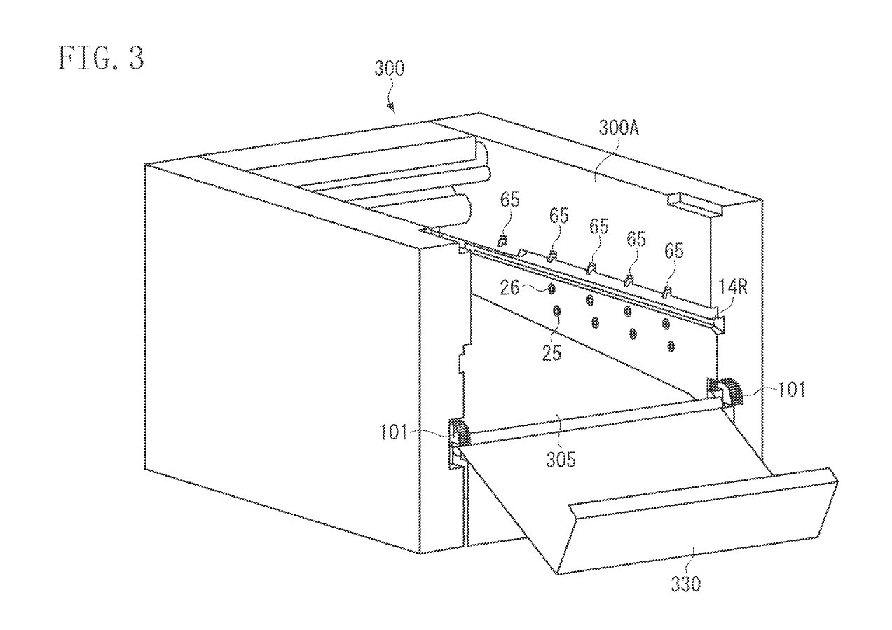

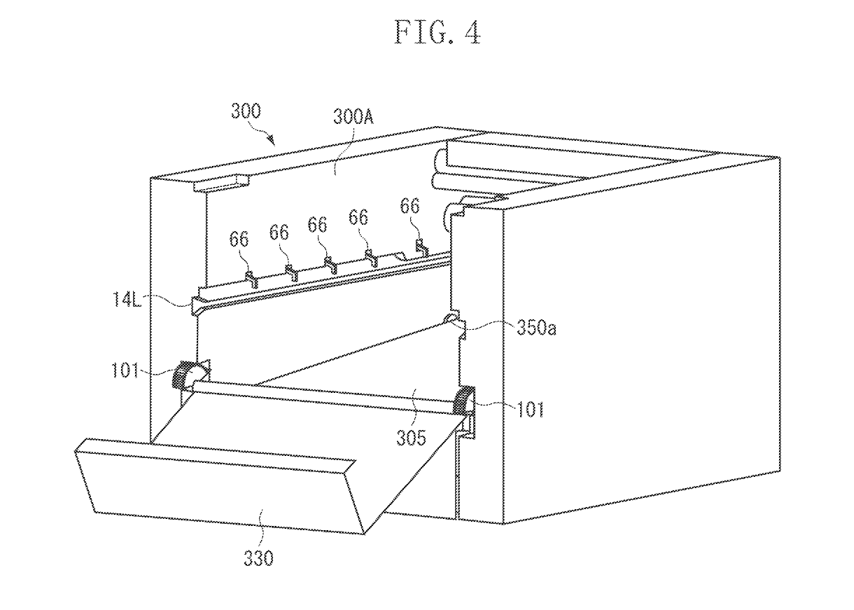

The construction of the attachment portion for the supporting member 13 in the apparatus body will be illustrated with reference to FIGS. 3 and 4. FIGS. 3 and 4 are perspective views of an attachment portion for the supporting member 13 in an apparatus body 300A of the image forming apparatus 300 according to the first exemplary embodiment of the present invention. In FIGS. 3 and 4, of the members (components) constituting the apparatus body, the scanner unit 303, etc. are omitted so that the construction of the attachment portion may be easily understood. FIGS. 3 and 4 are perspective views of the attachment portion as seen from different directions.

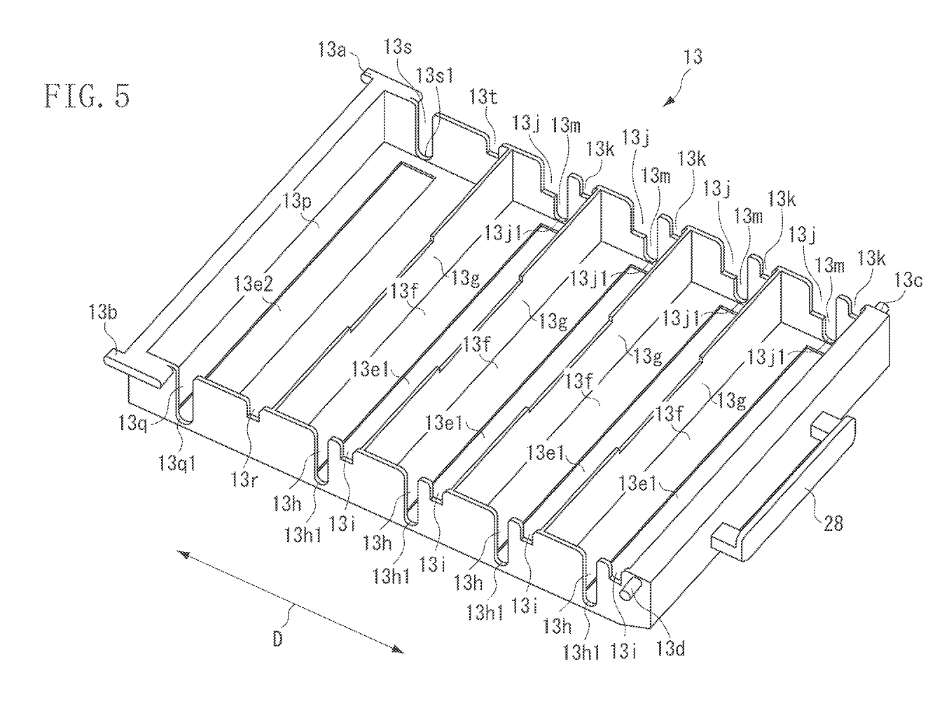

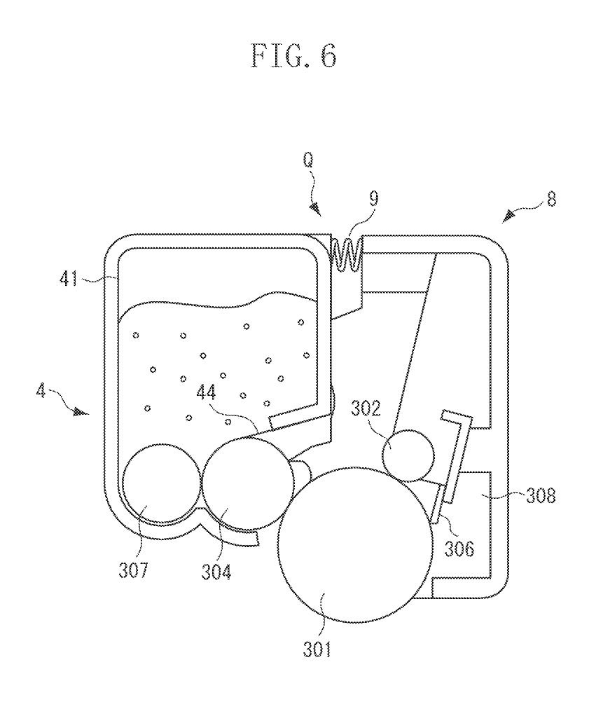

On inner wall surfaces of a frame 300A1 constituting a part of the apparatus body, a pair of guide portions 14R and 14L guiding the supporting member 13 in the moving direction thereof are provided so as to be located opposite each other. The guide portions 14R and 14L are portions configured to guide guided portions 13a, 13b, 13c, and 13d (See FIGS. 5 and 6) of the supporting member 13 described below; the guide portions are of a U-shaped sectional configuration. Further, the guide portions 14R and 14L are provided so as to extend substantially horizontally from a portion near the inlet of the apparatus body 300A (the portion near the door 330) to the depth side thereof so that the supporting member 13 can be guided from the position where it has been drawn out to the exterior of the apparatus body 300A to the position where it is accommodated in the apparatus body.

On the upper side of the guide portions 14R and 14L, there are provided pressing members 65 and 66 for setting the cartridges Q in position in a pressed state. The pressing members 65 and 66 are configured so as to be moved downwards by a force on the apparatus body 300A side, whereby the cartridges Q are pressed toward the transfer member 305. They are provided for the purpose of setting the cartridges Q at predetermined positions in the apparatus body 300A.

Further, as illustrated in FIG. 3, under the guide portion 14R, there are provided at equal horizontal intervals drum coupling members 26 for transmitting drive to the drums 301 and development coupling members 26 for transmitting drive to the developing rollers 40. The drum coupling members 25 and the development coupling members 26 transmit a driving force from a drive source (not illustrated) to the cartridges Q. In the state in which the door 330 is open, the drum coupling members 25 and the development coupling members 26 are retracted into the side walls; they are configured to enter the cartridges Q in synchronization with the operation of closing the door 330.

Referring to FIG. 5, the supporting member 13 will be illustrated in detail. FIG. 5 is a perspective view of a pullout unit in the image forming apparatus according to the first exemplary embodiment of the present invention.

At four corners of the supporting member 13, there are provided the guided portions 13a, 13b, 13c, and 13d guided by the guide portions 14R and 14L of the apparatus body. The guided portions 13a and 13c are guided by the guide portion 14R, and the guided portions 13b and 13d are guided by the guide portion 14L. The guided portions 13a and 13b are formed so as to outwardly protrude on the side surface sides; they are configured to extend in the pullout direction so that the supporting member 13 may not be tilted at the pullout position. The guided portions 13c and 13d are formed in a columnar configuration; they are configured to protrude on the outer sides of the side surfaces.

At one end of the supporting member 13, there is provided a handle portion 28 enabling the user to operate the supporting member 13.

Further, the supporting member 13 is provided with a row of attachment portions 13f for the attachment of the cartridges Q illustrated below. On the outer side of each attachment portion 13f, there is provided an attachment portion 13p for the attachment of the container 340. Between the attachment portions 13f and 13p, there are provided partitions 13g, which serve as a guide for attaching the cartridges Q and the container 340.

An opening 13e1 is provided in the lower portion of each attachment portion 13f. Through these openings 13e1, the drums 301 provided in the cartridges Q can be brought into contact with the transfer member 305.

At one side and the other side of each attachment portion 13f, there are provided guide portions 13h, 13i, 13j, and 13k for attaching the cartridge Q to the supporting member 13. Below the guide portions 13h and 13j, there are provided positioning portions 13h1 and 13j1 for performing positioning on the cartridges Q with respect to the supporting member 13.

Also at one end side and the other end side of the attachment portion 13p, there are provided guide portions 13q, 13r, 13s, and 13t for attaching the container 340 to the supporting member. Further, there are provided positioning portions 13q1 and 13s1 for performing positioning on the container 340 with respect to the supporting member 13. An opening 13e2 is provided in the lower portion of the attachment portion 13p. Through the opening 13e2, a cleaning roller 342 provided in the container 340 described below can be brought into contact with the transfer member 305.

As illustrated in FIG. 5, the supporting member 13 has in the guide portions 13i and 13j openings 13m allowing entrance of the drum coupling members 25 and the development coupling members 26 described above. The drum coupling members 25 and the development coupling members 26 enter the openings 13m in synchronization with the operation of closing the door 330. The drum coupling members 25 and the development coupling members 26 having entered the openings 13m are engaged with coupling members of the cartridges Q, thereby allowing drive transmission to the cartridges Q.

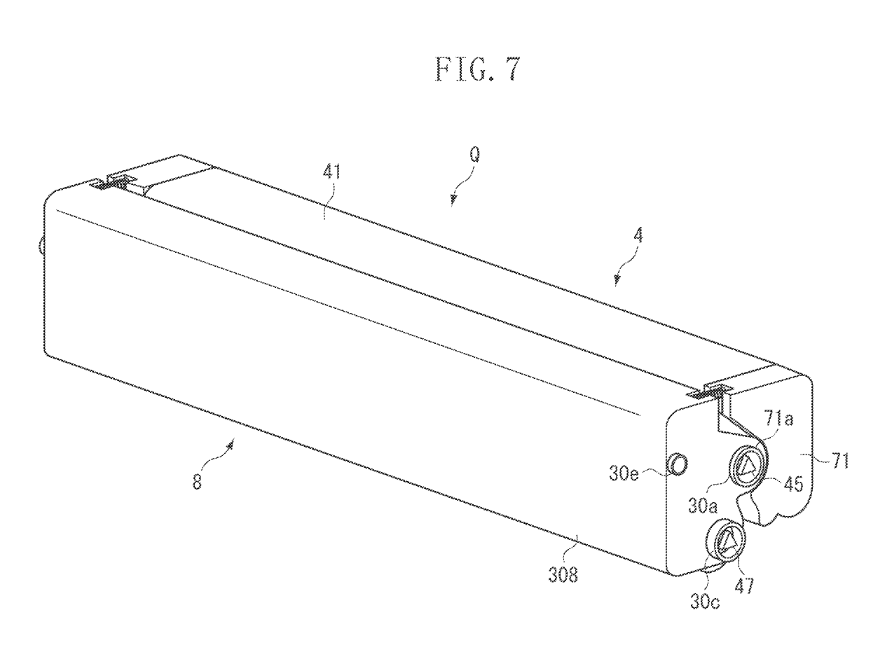

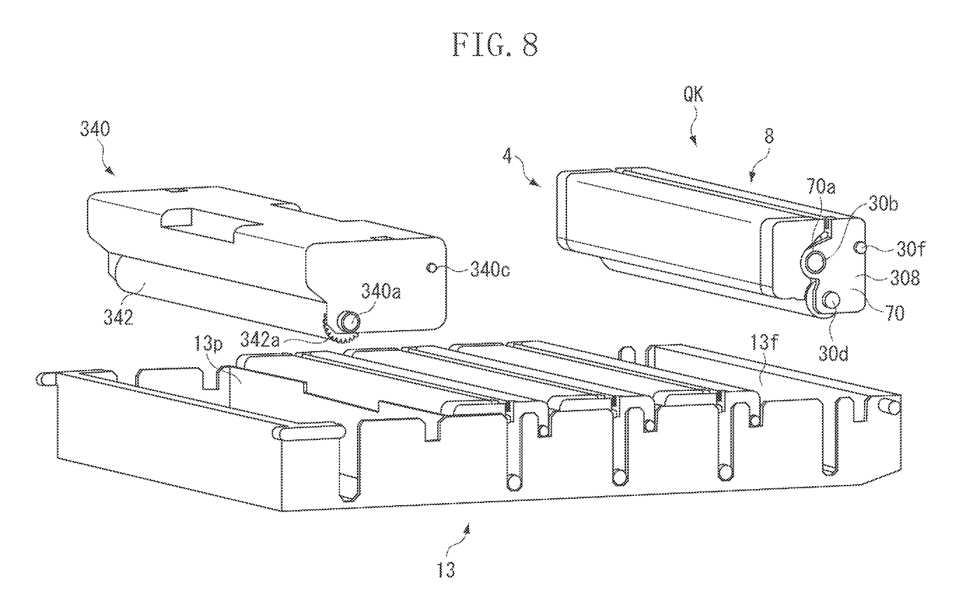

Next, the cartridges Q attached to the supporting member 13 will be illustrated with reference to FIGS. 6 through 8. FIG. 6 is a schematic sectional view of the cartridge Q according to the first exemplary embodiment of the present invention. FIG. 7 is a perspective view of the cartridge Q according to the first exemplary embodiment of the present invention. FIG. 8 is a perspective view illustrating how the cartridge Q according to the first exemplary embodiment of the present invention is attached to the supporting member 13.

The cartridge Q is composed of a photosensitive member unit 8 and a developing unit 4. The photosensitive member unit 8 is composed of the drum 301, a charging unit 302, a cleaning unit 306, and a cleaning container 308 storing the toner removed by the cleaning unit 306. The developing unit 4 is composed of a developing roller 304, a toner supply roller 307, a developing blade 44, and a toner container 41 storing toner to be used for image formation.

As described above, the toner in the toner container 41 is sent to the toner supply roller 307. By means of the toner supply roller 307 and the developing blade 44, which is held in press contact with the outer periphery of the developing roller 302, toner is applied to the outer periphery of the developing roller 302, and electric charge is imparted to the toner. The developing bias is applied to the developing roller 302 from the apparatus body, whereby toner adheres to the latent image formed on the drum 301 to form a toner image. After the toner image developed on the drum 301 has been transferred to the sheet material S, the toner remaining on the surface of the drum 301 is removed by the cleaning unit 306, and stored in the cleaning container 308.

When the toner in the toner container 41 has been consumed, the user can perform printing again by replacing the cartridge Q with a new one.

As illustrated in FIG. 7, at one end portion of the cartridge Q, a coupling member 47 for receiving a driving force from the drum coupling member 25 on the apparatus body side is rotatably supported. Further, a coupling member 45 for receiving a driving force from the development coupling member 26 is also rotatably supported.

The coupling member 47 is provided at one end of the drum 301, which is rotated by the driving force that the coupling member 47 receives from the apparatus body 300A. Further, the driving force that the coupling member 45 receives is transmitted to the developing roller 304 and the toner supply roller 307 via an intermediate gear (not illustrated), rotating these rollers.

The outer periphery of the coupling member 45 is covered with a cylindrical rib to form an engagement portion 71a. The engagement portion 71a is provided on a side cover 71 fixed to the outer side of the toner container 41. The coupling member 45 is rotatable with respect to the engagement portion 71a. Further, as illustrated in FIG. 8, an engagement portion 70a is provided on the side opposite to the engagement portion 71a. The engagement portion 70a is also provided on a side cover 70. Both the engagement portions 71a and 70a are provided on the developing unit 4.

The cleaning container 308 is provided with hole portions 30a and 30b supporting the engagement portions 71a and 70a. The hole portions 30a and 30b provided in the cleaning container 308 are engaged with the engagement portions 71a and 70a provided on the developing unit 4, whereby the photosensitive member unit 8 and the developing unit 4 are connected to each other.

The engagement portions 71a and 70a are movable (rotatable) with respect to the hole portions 30a and 30b, so that the developing unit 4 can move with respect to the photosensitive member unit 8. In other words, the developing roller 304 is movable with respect to the drum 301.

As illustrated in FIG. 6, a spring 9 serving as an urging member is provided between the photosensitive member unit 8 and the developing unit 4. The developing roller 304 is pressed against the drum 301 with a predetermined pressure by the spring 9.

As illustrated in FIG. 7, the outer periphery of the coupling member 47 is covered with a cylindrical rib to form a guide portion 30c. Further, as illustrated in FIG. 8, on the opposite side of the guided portion 30c in the longitudinal direction, there is provided a guided portion 30d composed of a cylindrical protrusion. Further, as illustrated in FIG. 7, a guided portion 30e is provided above the guided portion 30c, and, as illustrated in FIG. 8, a guided portion 30f is provided above the guided portion 30d. These guided portions 30c, 30d, 30e, and 30f serve to attach the cartridge Q to the supporting member 13 and to set it in position within the supporting member 13. The guided portions will be illustrated in detail below.

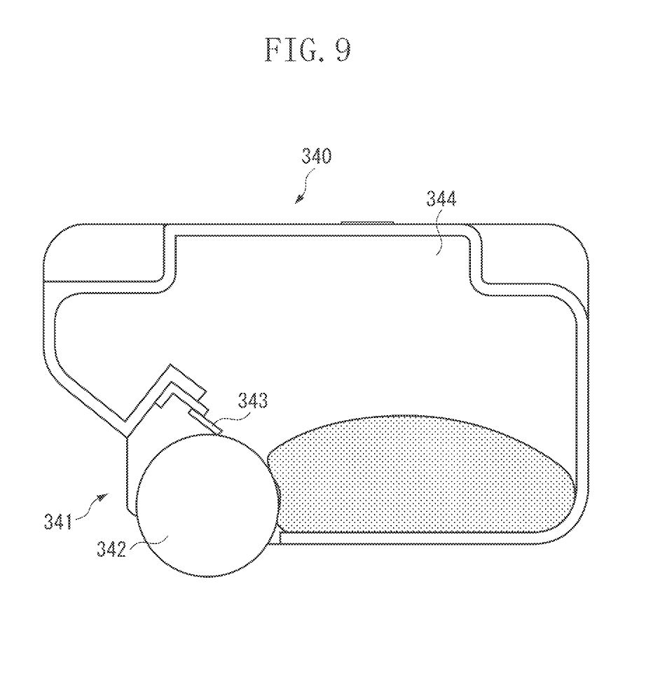

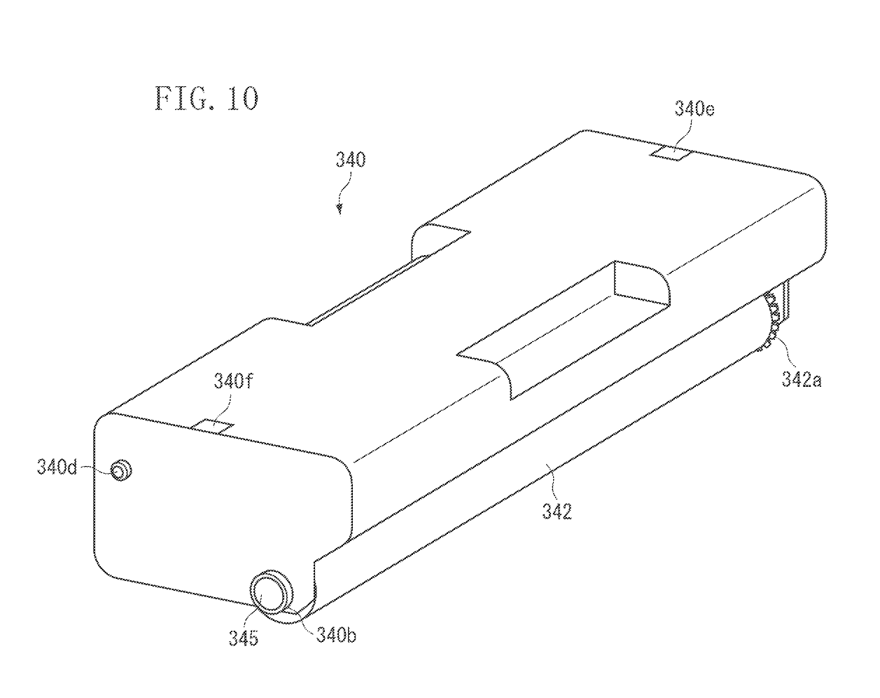

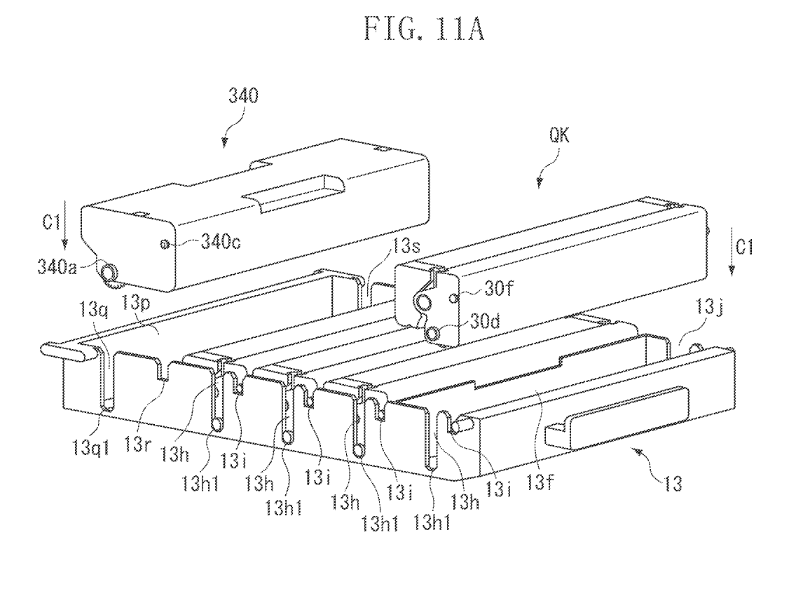

Next, the waste developer container 340 (hereinafter referred to as the container 340), which is attached to the supporting member 13, will be illustrated with reference to FIGS. 8 through 10. FIG. 8 is a perspective view illustrating how the container 340 according to the first exemplary embodiment of the present invention is attached to the supporting member 13. FIG. 9 is a schematic sectional view of the container 340 according to the first exemplary embodiment of the present invention. FIG. 10 is a perspective view of the container 340 according to the first exemplary embodiment of the present invention.

The container 340 is composed of a cleaning roller 342 and a cleaning blade 343, which constitute the cleaning member 341, and a storage portion 344 storing transfer residual toner recovered by the cleaning member 341.

As described above, the secondary transfer residual toner remaining on the surface of the transfer member 305 electrostatically adheres to the surface of the cleaning roller 342. A predetermined bias is imparted to the cleaning roller 342 from the apparatus body via a contact portion 345. A bias of a polarity opposite to the charging polarity of the developer and of a predetermined potential is applied with a predetermined control timing.

Further, a driving gear 342a is provided at a longitudinal end portion of the cleaning roller 342. Drive is transmitted to the driving gear 342a by a gear 350a provided at an end portion of a roller 350 located opposite the cleaning roller 342. The roller 350 makes a driven rotation with respect to the transfer member 305. The cleaning roller 342 rotates with a predetermined difference in peripheral velocity with respect to the transfer member 305 (The peripheral velocity of the cleaning roller 342 is higher than that of the transfer member 305). Due to the bias from the apparatus body 300A and the above-mentioned difference in circumferential velocity, residual toner is caused to adhere to the surface of the cleaning roller 342. Then, the adhering toner is scraped off by the cleaning blade 343 held in contact with the roller 342, and is stored in the storage portion 344 in the container 340. Instead of providing the cleaning roller 342, it is also possible to scrape off the toner by directly bringing the cleaning blade 343 into contact with the surface of the transfer member 305.

A guide portion 340a is provided on the outer surface of the container 340 and at one end portion of the roller 342. Further, as illustrated in FIG. 10, on the opposite side of the guide portion 340a in the longitudinal direction, there is provided a guided portion 340b. Further, as illustrated in FIG. 8, a guided portion 340c is provided above the guided portion 340a, and, as illustrated in FIG. 10, a guide portion 340d is provided above the guided portion 340b. These guided portions 340a, 340b, 340c, and 340d serve to attach the cartridges 13 to the supporting member 13 and to set them in position in the supporting member 13. The guided portions will be illustrated in detail below.

At both end portions of the upper surface of the container 340, there are provided pressed portions 340e and 340f to be pressed by pressing members 65 and 66 provided on the apparatus body 300A in order to set the container 340 in position within the apparatus body 300A.

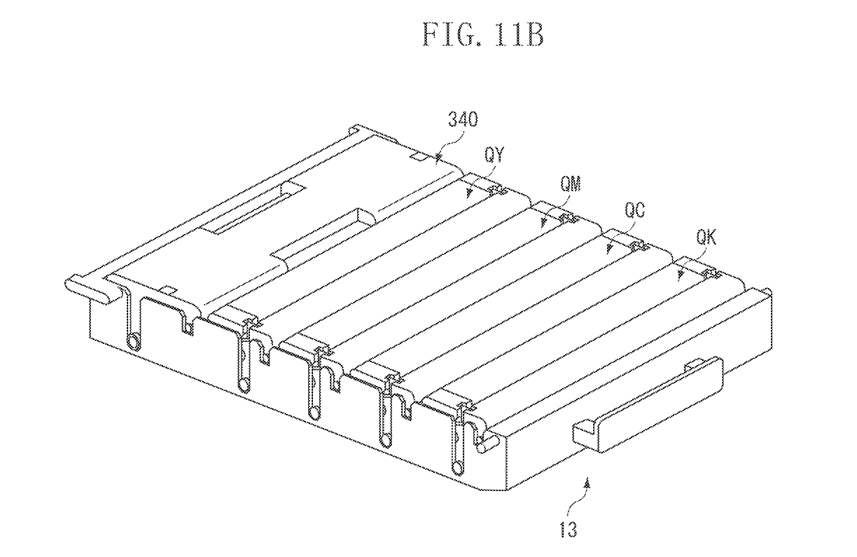

The attachment of the cartridges Q and the container 340 to the supporting member 13 will be described with reference to FIGS. 5, 11A, and 11B. FIG. 11A is a perspective view illustrating how the cartridges Q and the container 340 according to the first exemplary embodiment of the present invention are attached to the supporting member. In these figures, the apparatus body is omitted. FIG. 11 illustrates the state in which the cartridges Q and the container 340 have all been attached.

The cartridges QY, QM, QC, and QK are respectively attached to four attachment portions 13f provided on the supporting member 13. The user attaches the cartridges Q in the direction of the arrow C1, which is substantially the gravitational direction.

When attaching the cartridges Q, the user first attaches the guided portions 30c and 30d provided at both end portions of the cartridges so as to cause them to slide along the guide portions 13h and 13j of the supporting member 13. Next, the user attaches the guide portions 30e and 30f so as to cause them to slide along the guide portions 13h, 13i, 13j, and 13k. As a result, the cartridges Q are attached to the supporting member 13 while guided by the guide portions 13h, 13i, 13j, and 13k.

The guided portions 30c and 30d are set in position in positioning portions 13h1 and 13j1 provided in the lower portion of the supporting member 13. The guided portions 30e and 30f function as detents for the cartridges Q with respect to the supporting member 13.

The container 340 is attached to the supporting member 13 in the direction of the arrow C1. The attachment is effected so as to cause the guided portions 340a and 340b provided at both end portions of the container 340 to slide along the guide portions 13q and 13s of the supporting member 13. Subsequently, the guided portions 340c and 340d are attached so as to cause them to slide along the guide portions 13r and 13t.

The guide portions 340a and 340b are set in position by positioning portions 13q1 and 13s1 provided in the lower portion of the supporting member 13. The guided portions 340c and 340d function as detents for the container 340 with respect to the supporting member 13.

A plurality of cartridges Q are supported by the supporting member 13 while arranged in the moving direction of the supporting member 13. The container 340 is arranged adjacent to the cartridges Q in the moving direction.

As illustrated in FIG. 2, when attaching/detaching the cartridges Q and the container 340 to/from the apparatus body 300A, the supporting member 13 is pulled out to an attachment/detachment position B outside the apparatus body 300A. The attachment/detachment position B is a position allowing detachment of the cartridges Q and the container 340. The cartridges Q and the container 340 are attached and detached to and from the cartridges attachment portions 13f and the container attachment portion 13p pulled out to the position B. Then, as illustrated in FIG. 1, the supporting member 13 to which the cartridges Q and the container 340 have been attached is forced into the apparatus body 300A to be situated at the position A. As a result, the cartridges Q and the container 340 are moved to the image forming position where image formation is performed within the apparatus body 300A, enabling the cartridges Q and the container 340 to be attached to the apparatus body 300A. Thus, it is possible to achieve an improvement in terms of operability in the attachment and detachment of the cartridges Q and the container 340 to and from the apparatus body 300A.

An opening 300B is provided on the front side of the apparatus body 300A. The supporting member 13 supporting the cartridges Q, and the container 340 passes through the opening 300B. On the front side of the apparatus body 300A, a rotatable door 330 is arranged. The door 330 can assume a closed position where the opening 300B is closed and an open position where the opening 300B is open. In the present exemplary embodiment, the door 330 is rotatable with respect to the apparatus body 300A around a hinge portion 330a situated on the lower side of the door. In other words, to bring the 330 to the closed position, the door is rotated around the hinge portion 330a so as to be erected to close the opening 300B as illustrated in FIG. 1. To bring the door 330 to the open position, the door is rotated around the hinge portion 330a so as to fall on the front side of the apparatus body 300A to open the opening 300B as illustrated in FIG. 2. When the door 330 is situated at the open position, the supporting member 13 is allowed to pass through the opening 300B. In other words, the supporting member 13 is movable between the position A, where it is situated on the inner side of the apparatus body 300A to detachably support the plurality of cartridges Q and the container 340, and the position B, where it has been pulled out to the exterior of the apparatus body 300A from the position A.

As illustrated in FIG. 2, in the state in which the door 330 is open, the supporting member 13 passes through the opening 300B to move in a direction D1 while guided by guide units. In the present exemplary embodiment, the guide units include the guide portions 14R and 14L illustrated in FIGS. 3 and 4 and the guide portions 13h, 13i, 13j, and 13k. The guide portions 14R and 14L are provided substantially horizontally to extend in the longitudinal direction while located opposite the inner sides of the right and left side walls of the apparatus body 300A. The guide portions 13h, 13i, 13j, and 13k are provided on the right and left sides of the supporting member 13 and are slidable while fit-engaged with the guide portions 14R and 14L.

Thus, the supporting member 13 is provided so as to be movable with respect to the apparatus body 300A in the direction of the arrow D1 (forcing-in direction: backward direction) and in the direction D2 (pulling-out direction: forward direction), which is opposite thereto. The cartridges Q and the container 340 are attached to and supported by the corresponding attachment portions 13f and 13p of the supporting member 13 while arranged such that their longitudinally extending sides are adjacent to each other in the moving direction (the same direction as those indicated by the arrows D1 and D2) of the supporting member 13.

The longitudinal direction of the cartridges Q is the axial direction of the drums 301, and the longitudinal direction of the container 340 is the axial direction of the roller 304. In other words, the supporting member 13 supports the plurality of cartridges Q and the container 340 in a state in which they are arranged so as to be adjacent to each other in one direction. The supporting member 13 supports the plurality of cartridges Q and the container 340, with their longitudinal direction crossing the direction D1 (the direction D2) (substantially orthogonal thereto). Thus, the user can replace the container 340 in a manner similar to that of the replacement of the cartridges Q, which proves superior in terms of usability.

With the door 330 being open, the supporting member 13 can move the cartridges Q and the container 340 between the image forming position A, which is on the inner side of the apparatus body 300A, and the position B. The position B is a position to which the supporting member 13 is pulled out and which allows attachment and detachment of the cartridges Q and the container 340. The position A is a position at which the supporting member 13 supports the cartridges Q and the container 340; the position is in the interior of the apparatus body 300A, where electrostatic latent images can be formed on the drums 301. In this state, the cartridges Q are situated at the attachment positions with respect to the apparatus body 300A.

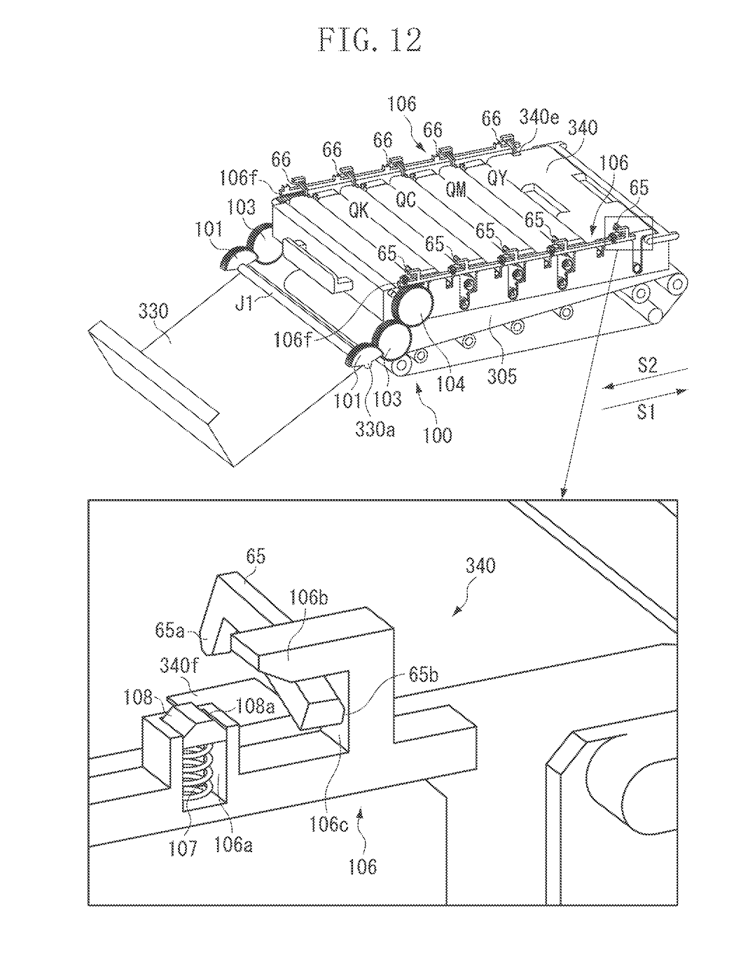

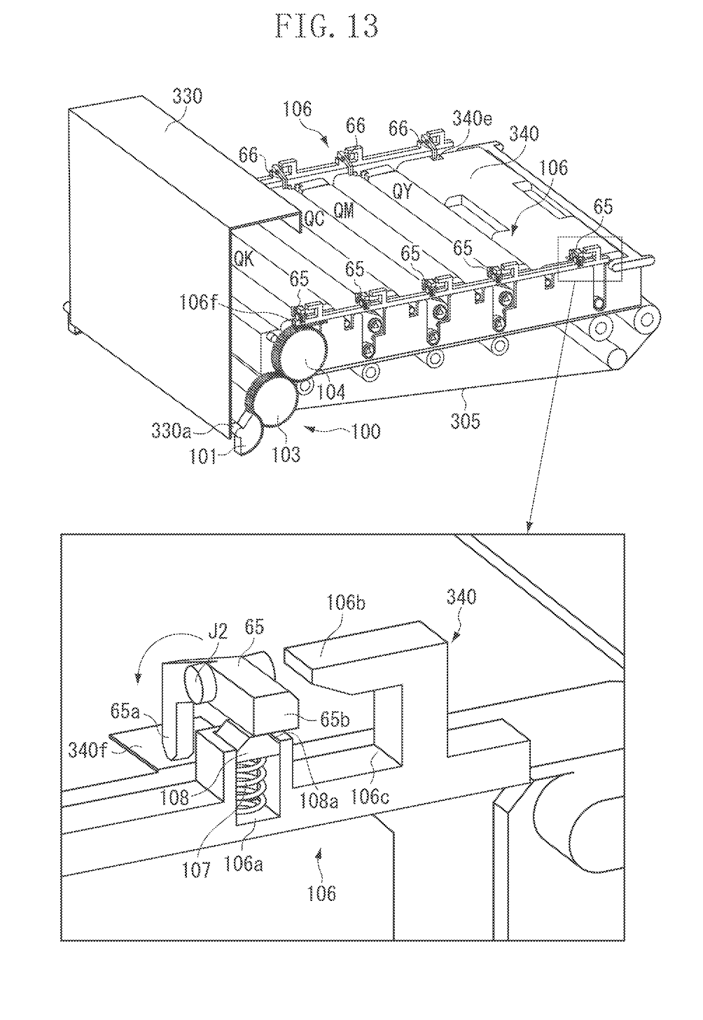

The positioning of the cartridges Q and the container 340 with respect to the apparatus body 300A will be illustrated FIGS. 12 and 13.

As described above, the apparatus body 300A is provided with the pressing members 65 and 66. The pressing members 65 and 66 are moved downwards through the operation of closing the door 330. The pressing members 65 and 66 are pressed against the upper surfaces of the cartridges Q and pressed portions 340e and 340f of the container 340. As a result, the cartridges Q and the container 340 are set in position with respect to the supporting member 13 and with respect to the apparatus body 300A.

The pressing members 65 and 66 are interlocked with the operation of opening/closing the door 330 via a transmission unit 100. In the state in which the door 330 is open (FIG. 2), the pressing members 65 and 66 are situated so as not to hinder the movement of the supporting member 13. Thus, they constitute no obstacle to the operation of attaching the supporting member 13. With the supporting member 13 being situated on the inner side of the apparatus body 300A, the door 330 is closed. As a result, the pressing members 65 and 66 urge the cartridges Q and the container 340 downwards.

FIG. 12 illustrates the door 330 in the open state, and FIG. 13 illustrates the door 330 in the closed state. The components other than the transmission unit 100 interlocking the door 330 with the pressing members 65 and interlocking the door 330 with the pressing members 66 are omitted.

As illustrated in FIG. 12, partially untoothed gears 101 are provided at both side end portions of a rotation shaft J1 of the door 330. The gears 101 rotate with the door 330. The gears 101 transmit drive to a rail unit 106 via intermediate gears 103 and transmission gears 104. At one end of the rail unit 106, there are provided rack portions 106f to be engaged with the gears 104. Thus, in response to the opening/closing operation of the door 330, the gears 103 and 104 rotate in the directions of arrows, making it possible to move the rail unit 106 in the directions of arrows S1 and S2. The intermediate gears 103, the transmission gears 104, and the rail unit 106 constitute the transmission unit 100.

The rail unit 106 is provided with urging members 107 urging the pressing members 65 and 66, and urging pieces 108 mounted to the distal ends of the urging members 107. The urging members 107 and the urging pieces 108 are both accommodated in recesses 106a, and are movable in the vertical direction. On the downstream side of the recesses 106a in the inserting direction of the supporting member 13, there are provided force imparting portions 106b for moving the pressing members 65 and 66 from pressing positions (FIG. 13) to non-pressing positions (FIG. 12). Since the pressing members 65 and 66 are of the same mechanism, the following description will be restricted to the mechanism of the pressing members 65.

First, in the state illustrated in FIG. 12, the operation of closing the door 330 is performed. The gear 101 causes the rail unit 106 to move in the direction of the arrow S1 via the gears 103 and 104. One end portion 65b of each pressing member 65, which has been at the non-pressing position (FIG. 12), abuts a tapered surface 108a provided on the urging piece 108, and the pressing member 65 rotates in the direction of the arrow around a rotation shaft J2. As illustrated in FIG. 13, through their rotational motion, pressers 65a provided at the other ends of the pressing members 65 elastically press the pressed portions 340e and 340f of the container 340 and the upper surfaces of the cartridges, whereby the container 340 and the cartridges Q are set in position inside the apparatus body 300A.

The urging members 107 and the urging pieces 108 are compressed within the recesses 106a, and press the container 340 and the cartridges Q with an urging force according the compression amount of the urging members 107. The position of the rail unit 106 at this time will be referred to as an acting position.

When predetermined image formation has been completed, and the door 330 is opened as illustrated in FIG. 12, the gear 101, the gear 103, and the gear 104 rotate in directions opposite to those mentioned above. The rail unit 106 moves in the direction of the arrow S2. Then, one end portions 65b of the pressing members 65 contacts the force imparting portions 106b provided in the rail unit 106, and the pressing members 65 rotate around the rotation shafts J2 to the non-pressing positions illustrated in FIG. 12. Inclined surfaces 106b1 are provided on the lower surfaces of the force imparting portions 106b, making it possible to press down the one end portions 65b.

The end portions 65b are accommodated in recesses 106c provided in the rail unit 106. The urging members 107 and the urging pieces 108 return to their former positions. The position of the rail unit 106 at this time will be referred to as a non-acting position.

As described above, the guided portions 30c and 30d of the cartridges Q are moved downwards along the guide portions 13h and 13j by the pressing members 65 and 66. Then, the guide portions 30c and 30d are finally brought into contact with positioning portions 13h1 and 13j1 to be brought to a stop. In this state, image formation is feasible (FIG. 1).

As described above, when the door 330 is closed, the image forming apparatus is placed in a state in which image formation is feasible, making it possible to perform the image forming operation by the above-described image forming process. In order that it may not be rubbed against the photosensitive drums 301 at the time of movement of the supporting member 13, the transfer member 305 is retracted by a separation unit (not illustrated). When the door 330 is closed, the separation state is released, and the drums 301 come into contact with the transfer member 305.

In this state, the drive output units (the drum coupling members 25 and the development coupling members 26) provided in the apparatus body 300A are connected with drive input units (coupling members 47 and coupling members 45) of the cartridges Q. Further, a feeding system (not illustrated) on the apparatus body 300A side is electrically connected with the electrical contacts (not illustrated) of the cartridges Q. Further, the cleaning roller 342 of the container 340 is held in contact with the transfer member 305, making it possible to collect secondary transfer residual toner from the transfer member 305.

When the door 330 is opened, the opening 300B of the apparatus body 300A is opened. Then, the handle portion 28 arranged on the front surface of the front frame of the supporting member 13 is exposed through the opening 300B. Further, due to an interlock mechanism (not illustrated) interlocked with the opening rotational motion of the door 330, the driving roller 305a side of the transfer member 305 is lowered to a predetermined position around the rotation center axis of a transfer opposition roller 305b. As a result, the transfer member 305 is separated from the lower surfaces of the drums 301 of the cartridges Q and the lower surface of the cleaning roller 342. Thus, the contact of the transfer member 305 with the drums 301 and the roller 342 is released.

Further, the connection of the drive output units on the apparatus body side with the drive input units of the cartridges Q is released (drive release). Further, the pressing of the pressing members setting the cartridges Q and the container 340 in position is released (pressing release). Further, the positioning fixation of the supporting member 13 with respect to the apparatus body 300A by a positioning fixation unit is released.

The user grabs the handle portion 28 and causes the supporting member 13 to slide horizontally forwards, i.e., in the pullout direction D2, with respect to the apparatus body 300A. Then, the user pulls out the supporting member 13 to a sufficient degree to the position B outside the apparatus body 300A from within the apparatus body 300A. When it has been pulled out to a sufficient degree to the predetermined position B, the supporting member 13 is prevented from being further pulled out by a stopper member (not illustrated). During the pulling-out of the supporting member 13, there is space between the drums 301 of the cartridges Q and the transfer member 305 and between the roller 342 of the container 340 and the transfer member 305. Thus, no rubbing occurs between them.

The supporting member 13 allows the individual cartridges Q and the container 340 to be upwardly extracted, and supports them when they are moved downwards. The user raises any used cartridge Q to be replaced from the supporting member 13 (as indicted by the upward arrow C2 of FIG. 2) to detach it from the supporting member. Then, the user drops a new cartridge Q on the supporting member 13 downwards from above, i.e., substantially in the gravitational direction (as indicated by the downward arrow C2). As a result, the new cartridge is supported by the supporting member 13. With the supporting member 13 being situated at the position B, the container 340 can also be attached and detached to and from the supporting member 13 in the directions of the arrows C1 and C2. That is, the cartridges Q and the container 340 are attached to and detached from the supporting member 13; in other words, their attachment/detachment directions with respect to the apparatus body 300A are the directions indicated by the arrows C1 and C2, i.e., substantially the gravitational direction.

When the operation of replacing the cartridges Q and the container 340 with respect to the supporting member 13 has been completed, the user causes the supporting member 13 to slide horizontally backwards, i.e., in the forcing-in direction D1, which is opposite to the pullout direction D2, with respect to the apparatus body 300A.

When the supporting member 13 has been forced in to a sufficient degree, the door 330 is closed. Through the operation of closing the door 330, the opening 300B of the apparatus body 300A is closed.

Further, in conjunction with the operation of closing the door 330, the container 340 and the cartridges Q are pressed by the pressing members 65 and 66 to be set in position at predetermined positions. Further, the drive output units on the apparatus body side are connected with the drive input units of the cartridges Q and the container 340. Further, the feeding system on the apparatus body side becomes electrically connected with the electrical contacts of the cartridges Q. Then, the roller 305a side of the transfer member 305 is raised to a predetermined position around the rotation center axis of the roller 305b. As a result, the transfer member 305 is brought into contact with the lower surfaces of the drums 301 of the cartridges Q and the roller 342 of the container 340. In this state, the image forming apparatus 300 can perform an image forming operation.

As described above, while supported by the supporting member 13, the plurality of cartridges Q and the container 340 enter the apparatus body 300A together with the supporting member 13. Thus, the user causes the supporting member 13 to enter the apparatus body 300A, and then closes the door 330. In this way, the plurality of cartridges Q and the container 340 can be reliably attached to the apparatus body 300A. Thus, as compared with the construction in which the user attaches the cartridges Q and the container 340 individually to the apparatus body 300A, it is possible to achieve an improvement in terms of attachment/detachment operability.

At the position A, the container 340 is being pressed toward the transfer member 305 by the pressing members 65 and 66. Thus, it is possible for the cleaning member 341 to reliably recover the waste developer on the transfer member 305. In other words, the positional relationship between the transfer member 305 and the cleaning member 341 is maintained such that they are not separated from each other by the pressing force of the pressing members 65 and 66. If the pressing force of the pressing members 65 and 66 is not exerted, there is the possibility of the cleaning member 341 being separated from the transfer member 305 due to shake, vibration, etc., of the transfer member 305 during its driving, which means it is impossible to reliably remove the waste developer.

On the other hand, in conjunction with the opening of the door 330, the pressing by the pressing members 65 and 66 is released, and the container 340 can move to the position B together with the supporting member 13. More specifically, at the position A, in order to reliably recover the waste developer on the transfer member 305, the container 340 is being pressed toward the transfer member 305 by the pressing members 65 and 66. However, when moving the container 340 to the position B, the pressing by the pressing members 65 and 66 is released, whereby it is possible to reliably move the container 340 to the replacement position.

Instead of moving the container as a whole, it is also possible to move solely the cleaning member between the cleaning position and the separating position.

As described above, the container 340 is enabled to be attached and detached to and from the supporting member 13, whereby it is possible for the user to perform the replacement of the cartridges Q and the replacement of the container 340 by the same method, which proves superior in terms of usability. Further, the attachment/detachment direction of the container 340 is set to be the same as the attachment/detachment direction of the cartridges Q, so that the user can easily perform both operations. Here, it is only necessary for the attachment/detachment of the container 340 and the cartridges Q to be performed without having to change the position of the supporting member 13, which means their attachment/detachment directions need not be exactly the same but may somewhat deviate from each other.

Further, the container 340 is arranged on the most upstream side of the supporting member 13 in the direction from the position A toward the position B (the direction indicated by the arrow D2). Generally speaking, the container 340 is replaced less frequently than the cartridges Q. Thus, by arranging the container 340, which is of the least replacement frequency, on the apparatus body 300A side, it is easy for the user to replace the cartridges Q, which are of higher replacement frequency. Thus, the cartridges Q can be replaced without having to pull out the supporting member 13 to the front side to a large degree, which helps to attain superior usability.

Further, on the supporting member 13, the container 340 is arranged nearer to the fixing device 323 than the cartridges Q. Due to this arrangement, the developers stored in the cartridges Q are not easily affected by the heat emitted from the fixing device 323. The waste developer stored in the container 340 is supposed to be disposed of, so that if it is affected by the heat of the fixing device 323, no problem is involved.

In the present exemplary embodiment described above, the developed images on the drums 301 are primarily transferred to the transfer member 305, and are then re-transferred to a recording medium S at a secondary transfer portion. However, the transfer member may also be of the type which transfers the developed images on the drums directly to the recording medium S.

The expression: “substantially horizontal” means “substantially horizontal with respect to the installation surface F of the image forming apparatus 300.” However, the supporting member 13 is not necessarily caused to make linear movement horizontally with respect to the installation surface F; for example, it is also possible for the supporting member to make linear movement obliquely upwards or obliquely downwards with respect to the installation surface F.

While in the present exemplary embodiment the present invention is applied to a color image forming apparatus having a plurality of cartridges, the present invention is also applicable to a monochrome image forming apparatus having a single cartridge.

The configuration of the image forming apparatus 300 according to the first exemplary embodiment will be summarized as follows: It is a color electrophotographic image forming apparatus 300 configured to form a color image on a recording medium S. It has a plurality of cartridges Q storing developers. Further, it has a transfer member 305 which is located opposite electrophotographic photosensitive drums 301 and which is configured to transfer developed images formed on the drums 301 to the recording medium S. Further, it has a supporting member 13, which, with the cartridges Q attached, is movable between a position A where image formation is performed in an apparatus body 300A of the image forming apparatus and a position B which is spaced away from the position A and which allows detachment of the cartridges. Further, it has a waste developer container 340 mounted to the supporting member 13 and equipped with a cleaning member 341 for removing developer remaining on the surface of the transfer member 305, the developer removed by the cleaning member 341 being stored in the container 340. When the supporting member 13 is situated at the position B, the container 340 can be attached and detached to and from the supporting member 13.

Next, a second exemplary embodiment of the present invention will be described. Regarding the present exemplary embodiment, solely the differences in construction and operation from the first exemplary embodiment described above will be described; the members whose construction and function are similar to those of the corresponding members according to the first exemplary embodiment are indicated by the same reference numerals, and a description of such members will not be repeated.

The present exemplary embodiment greatly differs from the first exemplary embodiment in the following point: In the first exemplary embodiment described above, the container 340 is pressed toward the transfer member 305, or the pressing is released, in conjunction with the opening/closing operation of the door 330 as the opening/closing member. On the other hand, in the present exemplary embodiment, the pressing of the container 340 and the cartridges Q is effected, or the pressing of the container 340 and the cartridges Q is released, by using the driving force of a motor.

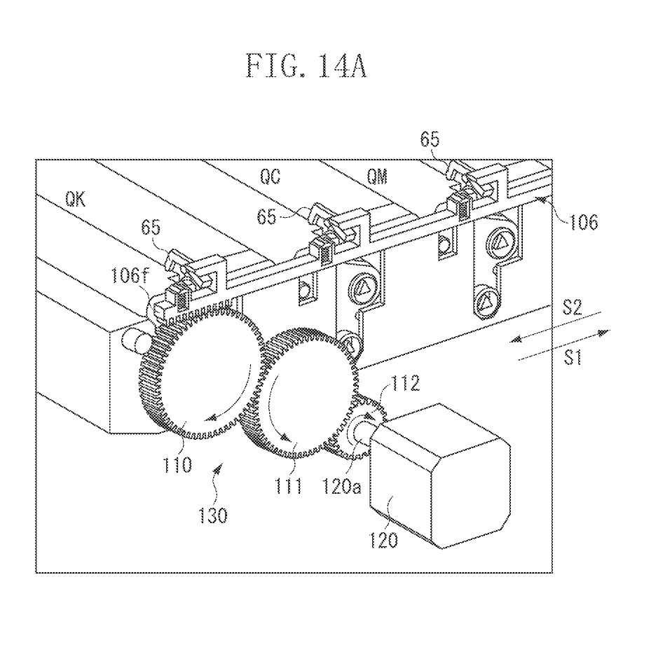

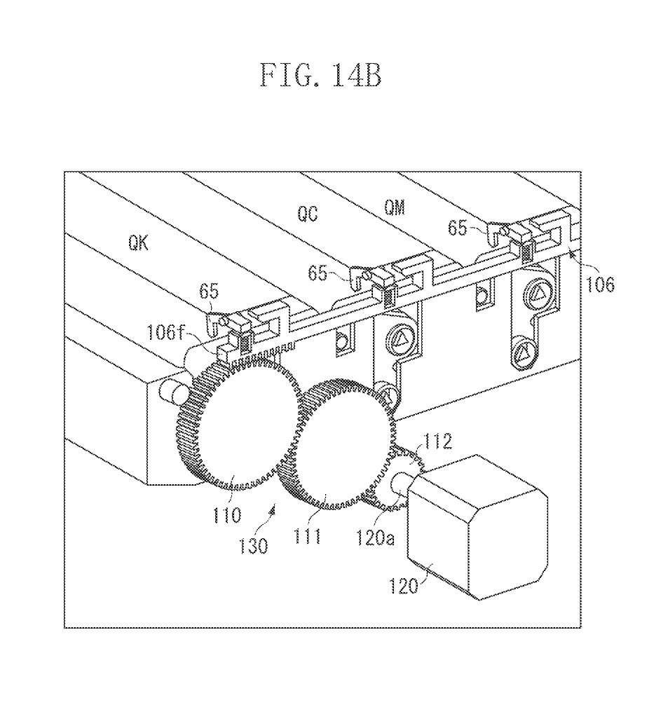

FIG. 14A is a perspective view illustrating a state in which the pressing members 65 are not acting on the cartridges Q and the container 340 (not illustrated). FIG. 14B is a perspective view illustrating a state in which the pressing members 65 are acting on the cartridges Q and the container 340 (not illustrated).

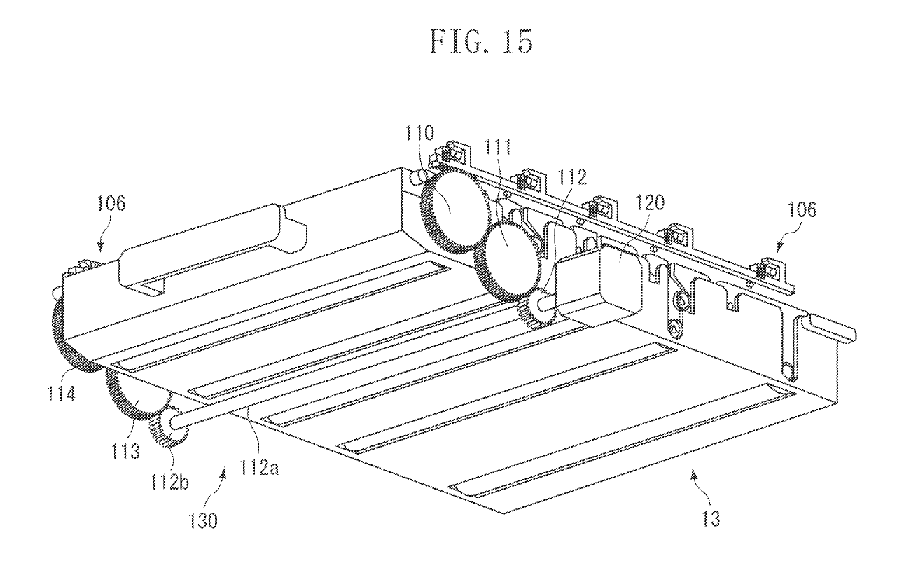

As in the first exemplary embodiment, a rack portion 106f is provided at an end portion of the rail unit 106. The rack portion 106f is in mesh with an intermediate gear 110. Further, the intermediate gear 110 is engaged with a motor gear 112 provided at an end portion of a motor 120 via a second intermediate gear 111. More specifically, through rotation of a shaft 120a of the motor 120, it is possible to move the rail unit 106 in the directions of arrows S1 and S2 via a transmission unit 130, which includes the motor gear 112, the second intermediate gear 111, the intermediate gear 110, and the rack portion 106f. As illustrated in FIG. 15, regarding the pressing members 66, drive is transmitted, due to a connection shaft 112a connected with the motor gear 112, to the portion of the rail unit 106 on the opposite side via a gear 112b, a second intermediate gear 113, and an intermediate gear 114.

After the supporting member 13 has been attached to the apparatus body 300A, the door 330 is closed. FIG. 14A is a diagram illustrating a state in which the supporting member 13 has been attached to the apparatus body 300A. At this time, the pressing members 65 and 66 are not pressing the container 340 and the cartridges Q yet (non-pressing position). After this, when an image formation command is issued, the motor 120 rotates in the direction of the arrow, pressing the container 340 and the cartridges Q as illustrated in FIG. 14B (pressing position). When the image formation has been completed, the motor 120 is rotated in the reverse direction to place the apparatus in the non-pressing position (FIG. 14A) again. The way the pressing members 65 and 66 are moved is the same as that in the first exemplary embodiment.

In this way, in the present exemplary embodiment, the pressing and the releasing of the pressing of the container 340 and the cartridges Q are effected not by the transmission force of the door 330 but by the transmission force of the motor 120. Thus, as compared with the first exemplary embodiment, it is possible to relieve the load involved when moving the door 330.

Thus, according to the above-described exemplary embodiments of the present invention, it is possible to provide an electrophotographic image forming apparatus improved in terms of the operation of replacing the cartridges storing developers and the waste developer container storing waste developer.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2010-212400 filed Sep. 22, 2010 and No. 2011-160154 filed Jul. 21, 2011, which are hereby incorporated by reference herein in their entirety.

What is claimed is:

1. An electrophotographic image forming apparatus for forming an image on a recording medium, the electrophotographic image forming apparatus comprising:
a cartridge configured to store developer;
a transfer member located opposite an electrophotographic photosensitive member and configured to transfer a developed image formed on the electrophotographic photosensitive member to the recording medium;
a supporting member that is movable, while supporting the cartridge, between an image forming position where image formation is conducted inside an apparatus body of the electrophotographic image forming apparatus and an attachment/detachment position which is spaced away from the image forming position and where attachment/detachment of the cartridge is feasible; and
a waste developer container supported so as to be attachable/detachable with respect to the supporting member, having a cleaning member configured to remove the developer from a surface of the transfer member, and configured to store the developer removed by the cleaning member.

2. The electrophotographic image forming apparatus according to claim 1, further comprising a pressing member configured to press the waste developer container toward the transfer member, wherein, when the supporting member is situated at the image forming position, the waste developer container is pressed, and wherein, when the waste developer container is detached from the supporting member, the pressing of the waste developer container is released.

3. The electrophotographic image forming apparatus according to claim 2, further comprising a transmission unit configured to impart an urging force to the pressing member to press the waste developer container.

4. The electrophotographic image forming apparatus according to claim 3, wherein the transmission unit includes an urging member configured to impart the urging force, and wherein the urging member can be moved between an acting position where the urging member is caused to act on the pressing member and a non-acting position where the urging member is not caused to act on the pressing member.

5. The electrophotographic image forming apparatus according to claim 4, wherein the transmission unit includes a force imparting portion configured to be engaged with the pressing member at the non-acting position to separate the pressing member from the waste developer container.

6. The electrophotographic image forming apparatus according to claim 3, further comprising:
an opening through which the supporting member is to be passed; and
an opening/closing member movable between an open position where the opening is open and where passage of the supporting member is allowed and a closed position where the opening is closed, and interlocked with the transmission unit,
wherein, when the opening/closing member is situated at the open position, the pressing of the pressing member is released by the transmission unit, and wherein, when the opening/closing member is moved to the closed position, the pressing member presses the waste developer container by the transmission unit.

7. The electrophotographic image forming apparatus according to claim 1, wherein the waste developer container is supported by the supporting member so as to beside by side with the cartridge in the moving direction of the supporting member, and wherein the waste developer container is arranged on the upstream side of the cartridge in a pullout direction in which the supporting member is moved from the image forming position to the attachment/detachment position.

8. The electrophotographic image forming apparatus according to claim 1, further comprising a fixing device configured to fix the developed image transferred to the recording medium to the recording medium,
wherein the waste developer container is arranged on the supporting member at a position nearer to the fixing device than the cartridge.

9. The electrophotographic image forming apparatus according to claim 1, wherein the cartridge includes the electrophotographic photosensitive member.

10. The electrophotographic image forming apparatus according to claim 1, wherein the supporting member supports a plurality of the cartridges configured to store developers of different colors.
